(19) United States
(12) Patent Application Publication
(10) Pub. No.: US 2026/0241705 A1
(43) Pub. Date: Aug. 20, 2026

(54) LIQUID DISCHARGE APPARATUS, LIQUID DISCHARGE SYSTEM, LIQUID DISCHARGE METHOD, AND STORAGE MEDIUM

(71) Applicant: Atsushi HADA, Kanagawa (JP)

(72) Inventor: Atsushi HADA, Kanagawa (JP)

(21) Appl. No.: 19/430,339

(22) Filed: Dec. 23, 2025

(30) Foreign Application Priority Data
Feb. 14, 2025 (JP) 2025-022617

(51) Int. Cl. B41J 2/21; B41J 3/44; H04N 1/00

(52) U.S. Cl. CPC B41J 2/2128; B41J 2/2103; B41J 2/2135; B41J 3/44; H04N 1/00795; H04N 2201/0081

(57) ABSTRACT

A liquid discharge apparatus includes a first head, a second head, and circuitry. The first head discharges liquid droplets to form a first dot pattern in a first area on a medium. The second head discharges the liquid droplets to form a second dot pattern in a second area partially overlapping the first area in a connection portion on the medium. The circuitry: controls the first head to discharge the liquid droplets having a first droplet type having a first droplet size and a second droplet type having a second droplet size larger than the first droplet size to form the first dot pattern in a part of the connection portion; and controls the second head to discharge the liquid droplets having the first droplet type and the second droplet type to form the second dot pattern in another part of the connection portion.

### CROSS-REFERENCE TO RELATED APPLICATION

This patent application is based on and claims priority pursuant to 35 U.S.C. § 119(a) to Japanese Patent Application No. 2025-022617, filed on Feb. 14, 2025, in the Japan Patent Office, the entire disclosure of which is hereby incorporated by reference herein.

### BACKGROUND

### Technical Field

The present disclosure relates to a liquid discharge apparatus, a liquid discharge system, a liquid discharge method, and a storage medium storing a plurality of instructions.

### Related Art

In the rerated art, a liquid discharge apparatus includes recording heads arranged in a staggered manner. The recording heads discharge liquid onto a recording medium to form an image. A first recording head discharges liquid to form dots, and a second recording head discharges liquid to form dots, to form the image. In this case, for example, due to insufficient adjustment of the recording heads or variations in the behavior of liquid droplets, a streak may appear in a connection portion of the image between the dots formed by the first recording head and the dots formed by the second recording head.

### SUMMARY

The present disclosure described herein provides an improved liquid discharge apparatus including a first head, a second head, and circuitry. The first head discharges liquid droplets onto a medium to form a first dot pattern in a first area on the medium. The second head discharges the liquid droplets onto the medium to form a second dot pattern in a second area on the medium. The second area partially overlaps the first area in a connection portion. The circuitry: controls the first head to discharge, onto a part of the connection portion, the liquid droplets having a first droplet type having a first droplet size and a second droplet type having a second droplet size larger than the first droplet size to form the first dot pattern in the part of the connection portion; and controls the second head to discharge, onto another part of the connection portion, the liquid droplets having the first droplet type and the second droplet type to form the second dot pattern in said another part of the connection portion, to form the first dot pattern and the second dot pattern having a mixture of the first droplet type and the second droplet in the connection portion.

Further, the present disclosure described herein provides an improved liquid discharge method and a non-transitory recording medium storing a plurality of instructions which, when executed by one or more processors, causes the one or more processors to perform the liquid discharge method. The liquid discharge method includes: causing a first head to discharge liquid droplets onto a medium to form a first dot pattern in a first area on the medium; causing a second head to discharge the liquid droplets onto the medium to form a second dot pattern in a second area on the medium, the second area partially overlapping the first area in a connection portion; controlling the first head to discharge, onto a part of the connection portion, the liquid droplets having: a first droplet type having a first droplet size; and a second droplet type having a second droplet size larger than the first droplet size, to form the first dot pattern in the part of the connection portion; and controlling the second head to discharge, onto another part of the connection portion, the liquid droplets having: the first droplet type; and the second droplet type, to form the second dot pattern in said another part of the connection portion, to form the first dot pattern and the second dot pattern having a mixture of the first droplet type and the second droplet in the connection portion.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating a configuration of a liquid discharge system;

FIG. 2 is a diagram illustrating a configuration of a head array of an image forming unit;

FIG. 3 is a diagram illustrating a configuration of hardware blocks of an image forming system;

FIG. 4 is a diagram illustrating drive waveforms generated by a drive waveform generation circuit;

FIG. 5 is a flowchart of control executed by a control unit of an image forming system for connection processing;

FIG. 6 is a diagram illustrating a principle of occurrence of a streak and unevenness in a connection portion;

FIG. 7 is a diagram illustrating an arrangement of dots formed of ink landed in a connection portion;

FIG. 8 is a diagram illustrating a connection portion to which a gradation pattern is applied;

FIG. 9 is a diagram illustrating a first example of a connection pattern;

FIG. 10 is a diagram illustrating a second example of a connection pattern;

FIG. 11 is a diagram illustrating a third example of a connection pattern; and

FIG. 12 is a diagram illustrating a fourth example of a connection pattern.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

A liquid discharge apparatus, a liquid discharge system, a liquid discharge method, and a storage medium storing a plurality of instructions will be described below in detail with reference to the accompanying drawings.

An inkjet image forming system as a liquid discharge system will be described below. In the following description, an image forming apparatus corresponds to a “liquid discharge apparatus,” and a sheet feeding apparatus, a drying apparatus, and a sheet ejection apparatus correspond to a “processing apparatus.” A sheet corresponds to a “recording medium.” The recording medium may be referred to simply as a medium. A scanner corresponds to a “reader.”

An embodiment of the present disclosure is not limited thereto. Other configurations may be adopted. For example, the “processing apparatus” may include at least one of the sheet feeding apparatus, the drying apparatus, or the sheet ejection apparatus. The processing apparatus may include an apparatus other than the sheet feeding apparatus, the drying apparatus, and the sheet ejection apparatus.

In the present disclosure, the liquid (liquid droplets or droplets) to be discharged is not limited to a particular liquid as long as the liquid has a viscosity or surface tension to be discharged from a head (liquid discharge head). However, preferably, the viscosity of the liquid is not greater than 30 millipascal-second (mPa·s) under ordinary temperature and ordinary pressure or by heating or cooling. More specifically, examples of the liquid to be discharged include a solution, a suspension, or an emulsion including, for example, a solvent, such as water or an organic solvent; a colorant, such as dye or pigment; a functional material, such as a polymerizable compound, a resin, or a surfactant; a biocompatible material, such as deoxyribonucleic acid (DNA), amino acid, protein, or calcium; and an edible material, such as a natural colorant. Such a solution, a suspension, or an emulsion can be used for, e.g., inkjet ink; surface treatment liquid; a liquid for forming an electronic element component, a light-emitting element component, or an electronic circuit resist pattern; or a material solution for three-dimensional fabrication.

Examples of an energy generator for generating energy to discharge liquid include a piezoelectric actuator (a laminated piezoelectric element or a thin-film piezoelectric element), a thermal actuator that employs a thermoelectric transducer, such as a thermal resistor, and an electrostatic actuator including a diaphragm and opposed electrodes.

A “liquid discharge unit” is an example of a liquid discharge head. The “liquid discharge unit” is an assembly of parts relating to liquid discharge. The term “liquid discharge unit” represents a structure including the liquid discharge head and a functional component(s) or mechanism(s) combined with the liquid discharge head as a single unit. For example, the “liquid discharge unit” includes a combination of the liquid discharge head with at least one of a head tank, a carriage, a supply mechanism, a maintenance mechanism, a main-scanning moving mechanism, or a liquid circulation device.

The above integration may be achieved by, for example, a combination in which the liquid discharge head and a functional component(s) or mechanism(s) are fixed to each other through, e.g., fastening, bonding, or engaging, and a combination in which one of the liquid discharge head and the functional component(s) or mechanism(s) is movably held to the other. The liquid discharge head and the functional component(s) or mechanism(s) may be detachably attached to each other.

For example, the liquid discharge head and the head tank are integrated to form the liquid discharge unit as a single unit. Alternatively, the liquid discharge head and the head tank coupled (connected) to each other via, for example, a tube may form the liquid discharge unit as a single unit. A unit including a filter may further be added to a portion between the head tank and the liquid discharge head of the liquid discharge unit.

In another example, the liquid discharge unit may be an integrated unit in which a liquid discharge head is integrated with a carriage.

As yet another example, the liquid discharge unit is a unit in which the liquid discharge head and the main-scanning moving mechanism are combined into a single unit. The liquid discharge head is movably held by a guide that is a part of the main-scanning moving mechanism. The liquid discharge unit may include the liquid discharge head, the carriage, and the main-scanning moving mechanism that are integrated as a single unit.

In another example, a cap that forms a part of the maintenance mechanism is fixed to the carriage mounting the liquid discharge head so that the liquid discharge head, the carriage, and the maintenance mechanism are integrated as a single unit to form the liquid discharge unit.

Further, in still another example, the liquid discharge unit includes a tube(s) connected to the liquid discharge head mounting the head tank or the channel component so that the liquid discharge head and the supply mechanism are integrated as a single unit. Through the tube, the liquid in a liquid storage source is supplied to the liquid discharge head. The main-scanning moving mechanism may be a guide only. The supply mechanism may be a tube(s) only or a loading device only.

The “image forming apparatus” includes an apparatus including the liquid discharge head (may be referred to as the liquid discharge unit) to drive the liquid discharge head to discharge liquid. The liquid discharge apparatus may be, for example, any apparatus that can discharge liquid to a medium onto which liquid can adhere or any apparatus to discharge liquid toward gas or into a different liquid.

The “image forming apparatus” may further include devices relating to feeding, conveying, and ejecting of the medium onto which liquid can adhere and also include a pretreatment device and an aftertreatment device.

The “image forming apparatus” may be, for example, an apparatus to form an image on a sheet by discharging ink, or a three-dimensional fabrication apparatus to discharge fabrication liquid to a powder layer in which powder material is formed in layers to form a three-dimensional object.

The “image forming apparatus” is not limited to an apparatus that discharges liquid to visualize meaningful images such as letters or figures. For example, the image forming apparatus may be an apparatus that forms patterns having no meaning or an apparatus that fabricates three-dimensional images.

The above-described term “medium onto which liquid can adhere” represents a medium on which liquid is at least temporarily adhered, a medium on which liquid is adhered and fixed, or a medium into which liquid adheres and permeates. Specific examples of the “medium onto which liquid can adhere” include, but are not limited to, a recording medium such as a paper sheet, recording paper, a recording sheet of paper, a film, or cloth, an electronic component such as an electronic substrate or a piezoelectric element, and a medium such as layered powder, an organ model, or a testing cell. The “medium onto which liquid can adhere” includes any medium to which liquid adheres, unless otherwise specified.

Examples of materials for the “medium onto which liquid can adhere” include any materials to which liquid can adhere even temporarily, such as paper, thread, fiber, fabric, leather, metal, plastic, glass, wood, and ceramic.

The term “image forming apparatus” may be an apparatus in which the liquid discharge head and the medium onto which liquid can adhere move relative to each other. However, the image forming apparatus is not limited to such an apparatus. For example, the image forming apparatus may be a serial head apparatus that moves the liquid discharge head or a line head apparatus that does not move the liquid discharge head.

Examples of the “image forming apparatus” further include: a treatment liquid applying apparatus that discharges a treatment liquid onto a sheet to apply the treatment liquid to the surface of the sheet, for reforming the surface of the sheet; and an injection granulation apparatus that injects a composition liquid, in which a raw material is dispersed in a solution, through a nozzle to granulate fine particles of the raw material.

The terms “image formation,” “recording,” “printing,” “image printing,” and “fabricating” used herein may be used synonymously with each other.

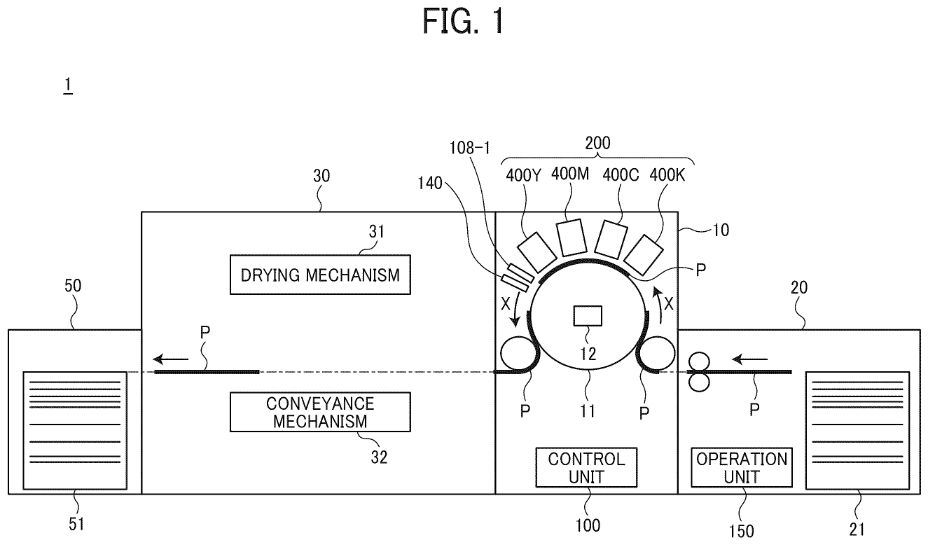

FIG. 1 is a diagram illustrating a configuration of a liquid discharge system. FIG. 1 illustrates a configuration of an inkjet image forming system as a liquid discharge system. An image forming system 1 illustrated in FIG. 1 includes an image forming apparatus 10, a sheet feeding apparatus 20 (sheet feeder), a drying apparatus 30 (dryer), and a sheet ejection apparatus 50 (sheet ejector).

The sheet feeding apparatus 20 includes a sheet feeding tray 21 on which a plurality of sheets P is stacked. The image forming apparatus 10 includes a sheet bearing drum 11. The leading end of the sheet P fed from the sheet feeding apparatus 20 is gripped by a sheet gripper disposed on the surface of the sheet bearing drum 11, and the sheet P is sent in a circumferential direction of the sheet bearing drum 11 by the rotation of the sheet bearing drum 11. The circumferential direction of the sheet bearing drum 11 is a sheet conveyance direction X in this example. A plurality of suction holes is formed on the surface of the sheet bearing drum 11, and a suction device 12 generates a suction airflow toward the inside of the sheet bearing drum 11 to attract the sheet P along the surface of the sheet bearing drum 11. As the sheet bearing drum 11 rotates, the sheet P is conveyed in the sheet conveyance direction X.

In the sheet conveyance direction X, an image forming unit 200, a sensor 108-1 that detects the sheet P, and a scanner 140 that reads an image formed on the sheet P are disposed so as to face the surface of the sheet bearing drum 11. The image forming unit 200 corresponds to a “liquid discharge unit.”

The image forming unit 200 is an inkjet liquid discharge unit. For example, the image forming unit 200 includes head arrays for four colors (e.g., a head array 400K, a head array 400C, a head array 400M, and a head array 400Y). The image forming apparatus 10 feeds the sheet P one by one from the sheet feeding apparatus 20, carries the sheet P on the sheet bearing drum 11, and sequentially discharges ink from the head array 400K, the head array 400C, the head array 400M, and the head array 400Y onto the sheet P carried on the sheet bearing drum 11 to form an image on the sheet P.

The drying apparatus 30 conveys the sheet P on which an image has been formed by the image forming apparatus 10 with a conveyance mechanism 32, dries the image with a drying mechanism 31, and then conveys the sheet P to the sheet ejection apparatus 50. The sheet ejection apparatus 50 stacks the sheets P sequentially sent by the conveyance mechanism 32 on a sheet ejection tray 51.

A control unit 100 as circuitry controls the operation of the entire image forming system 1. The configuration of the control unit 100 will be described in detail later. An operation unit 150 is a user interface for a user to operate the image forming system 1. The operation unit 150 is, for example, a touch panel or a keyboard.

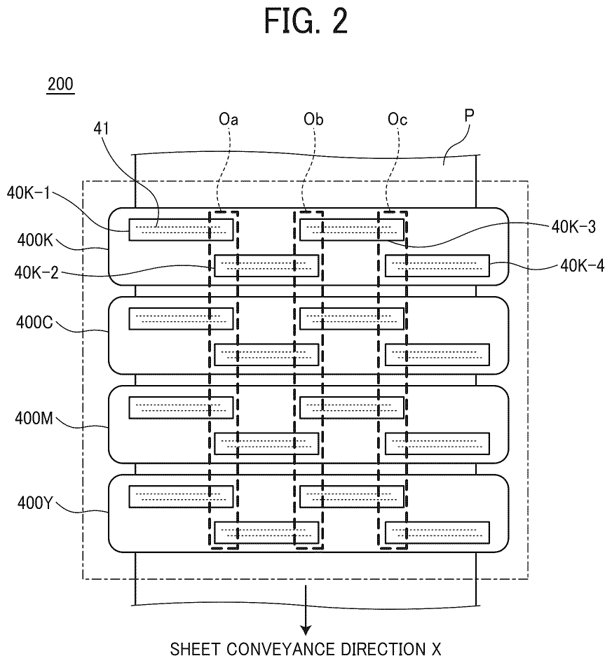

FIG. 2 is a diagram illustrating a configuration of a head array of the image forming unit 200. As illustrated in FIG. 2, the image forming unit 200 includes the head array 400K for black (K), the head array 400C for cyan (C), the head array 400M for magenta (M), and the head array 400Y for yellow (Y) in this order from the upstream side in a conveyance direction (sheet conveyance direction X) of the sheet P.

Each of the head array 400K, the head array 400C, the head array 400M, and the head array 400Y includes four recording heads each having two nozzle rows 41. In other words, the image forming unit 200 includes 16 recording heads each having 2 nozzle rows (2 rows×16 heads).

In the head array 400K, four recording heads (a recording head 40K-1, a recording head 40K-2, a recording head 40K-3, and a recording head 40K-4) are alternately arranged in a staggered manner. In the other head array 400C, head array 400M, and head array 400Y, similarly to the configuration of the head array 400K, four recording heads each having two nozzle rows 41 are alternately arranged in a staggered manner.

Since each head array (head array 400K, head array 400C, head array 400M, and head array 400Y) includes the recording heads arranged in a staggered manner, an end of the nozzle row 41 of each recording head overlaps an end of the nozzle row 41 of another adjacent recording head in the sheet conveyance direction X as indicated by dashed lines Oa, Ob, and Oc in FIG. 2. In the following description, the recording head may be referred to simply as a “head.”

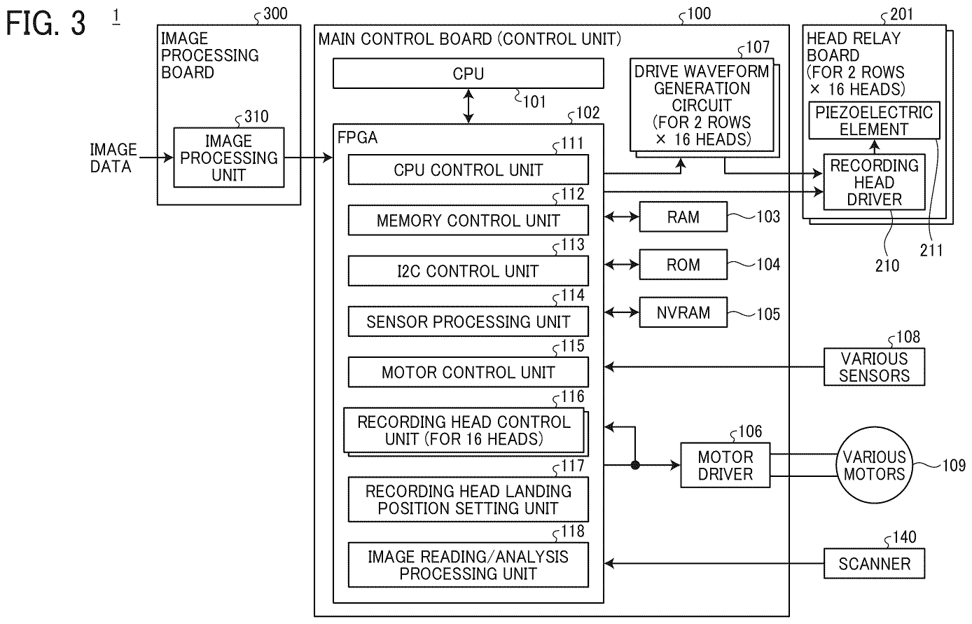

FIG. 3 is a diagram illustrating a configuration of hardware blocks of the image forming system 1. As illustrated in FIG. 3, the image forming system 1 includes a main control board corresponding to the control unit 100 illustrated in FIG. 1, a head relay board 201, and an image processing board 300.

The main control board (control unit 100) includes a central processing unit (CPU) 101, a field-programmable gate array (FPGA) 102, a random-access memory (RAM) 103, a read-only memory (ROM) 104, and a nonvolatile random-access memory (NVRAM) 105, a motor driver 106, and a drive waveform generation circuit 107.

The CPU 101 controls the entire image forming system 1. For example, the CPU 101 uses the RAM 103 as a work area, executes various control programs stored in the ROM 104 to function as a control unit. The CPU 101 outputs a control command for controlling various operations in the image forming system 1. At this time, the CPU 101 controls the various operations in the image forming system 1 in cooperation with the FPGA 102 while communicating with the FPGA 102.

The FPGA 102 includes a CPU control unit 111, a memory control unit 112, an I2C control unit 113, a sensor processing unit 114, a motor control unit 115, a recording head control unit 116, a recording head landing position setting unit 117, and an image reading/analysis processing unit 118.

The CPU control unit 111 has a function to communicate with the CPU 101. The memory control unit 112 has a function to access the RAM 103 and the ROM 104. The I2C control unit 113 has a function to communicate with the NVRAM 105.

The sensor processing unit 114 processes sensor signals of various sensors 108 installed in the image forming system 1. The various sensors 108 are a generic term for sensors in the image forming system 1, and include the sensor 108-1.

The motor control unit 115 controls the motor driver 106 to drive various motors 109 in the image forming system 1. The various motors 109 are, for example, conveyance motors for the sheet P.

The recording head control unit 116 transmits head drive data, a discharge synchronization signal, and a discharge timing signal stored in the ROM 104 to the drive waveform generation circuit 107 to cause the drive waveform generation circuit 107 to generate a common drive waveform signal Vcom. The common drive waveform signal Vcom generated by the drive waveform generation circuit 107 is input to a recording head driver 210 mounted on the head relay board 201.

The recording head landing position setting unit 117 adjusts the landing positions between the rows of each recording head, between the recording heads for the same color (e.g., the recording head 40K-1, the recording head 40K-2, the recording head 40K-3, and the recording head 40K-4), and between the head arrays of different colors (e.g., the head array 400K, the head array 400C, the head array 400M, and the head array 400Y) based on the result obtained by the image reading/analysis processing unit 118. Further, the recording head landing position setting unit 117 controls a connection pattern.

The image reading/analysis processing unit 118 causes the scanner 140 to read an image and analyzes the image read by the scanner 140. Further, the image reading/analysis processing unit 118 determines whether a streak or unevenness is included in the read image by the analysis processing. For example, the unevenness refers to color unevenness.

The head relay board 201 includes the recording head driver 210 and a piezoelectric element 211. In the configuration illustrated in FIG. 3, the drive waveform generation circuit 107 is on the main control board (control unit 100) in the body of the image forming apparatus 10, and the recording head driver 210 is mounted on the head relay board 201 for each row of the recording heads (e.g., the recording head 40K-1, the recording head 40K-2, the recording head 40K-3, and the recording head 40K-4). The drive waveform generation circuit 107 generates a drive waveform for each row of the recording heads (e.g., the recording head 40K-1, the recording head 40K-2, the recording head 40K-3, and the recording head 40K-4). The recording head driver 210 of the head relay board 201 drives the piezoelectric element 211 based on the drive waveform generated by the drive waveform generation circuit 107 to cause the recording heads (e.g., the recording head 40K-1, the recording head 40K-2, the recording head 40K-3, and the recording head 40K-4) to discharge ink droplets (droplets) from each row of the recording heads. The image processing board 300 performs image processing on image data using an image processing unit 310 and outputs the data to the FPGA 102.

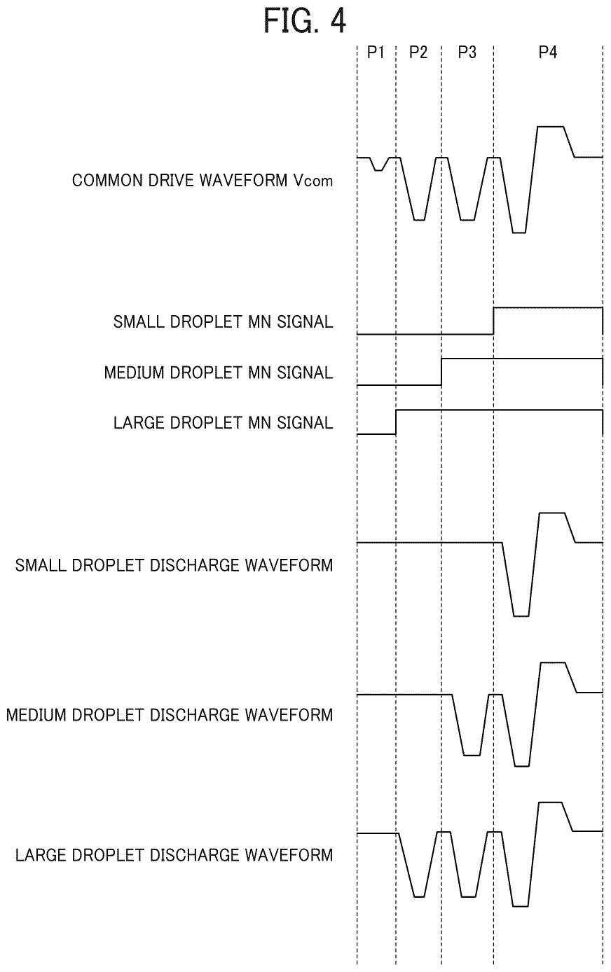

FIG. 4 is a diagram illustrating an example of a drive waveform generated by the drive waveform generation circuit 107. As illustrated in FIG. 4, as an example, the liquid discharge is controlled by selectively using three types of droplets: small droplets, medium droplets, and large droplets. The ink droplets have droplet types of sizes of small droplets, medium droplets, and large droplets, and the volume of the ink droplets increases in this order. For example, the droplet size is referred to as the volume of one droplet, the diameter of the droplet, or the cross-sectional area of the droplet. The common drive waveform Vcom illustrated in FIG. 4 is output to the recording head driver 210. The drive waveform generation circuit 107 outputs a selection signal (a small droplet MN signal, a medium droplet MN signal, or a large droplet MN signal illustrated in FIG. 4) of one of the three types of droplets: the small droplets, the medium droplets, and the large droplets to the recording head driver 210 based on an instruction from the FPGA 102.

When the small droplet MN signal illustrated in FIG. 4 is output, the recording head driver 210 drives the piezoelectric element 211 with a small droplet discharge waveform indicated in phase P4 included in the common drive waveform Vcom to discharge the small droplets. When the medium droplet MN signal is output, the recording head driver 210 drives the piezoelectric element 211 with a medium droplet discharge waveform indicated in phases P3 and P4 included in the common drive waveform Vcom to discharge the medium droplets. When the large droplet MN signal is output, the recording head driver 210 drives the piezoelectric element 211 with a large droplet discharge waveform indicated in phases P2 to P4 included in the common drive waveform Vcom to discharge the large droplets. Accordingly, the liquid discharge is controlled to discharge small droplets, medium droplets, or large droplets from each nozzle.

In overlapping ranges indicated by the dashed lines Oa, Ob, and Oc in FIG. 2, the recording heads overlapping each other discharge the droplets in a discharge pattern in which different types of droplets such as small droplets, medium droplets, and large droplets are combined to form dots of the connection pattern. The dot configuration of the connection pattern is set by a discharge pattern (corresponding to a dot discharge pattern) applied to the overlapping range. In the following description, a change in the discharge pattern (dot configuration) corresponding to the overlapping range is referred to as connection processing.

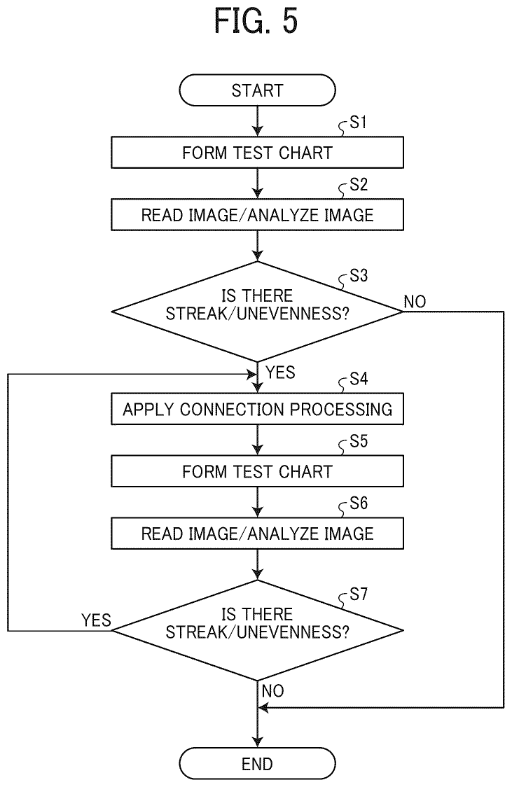

FIG. 5 is a flowchart of control executed by the control unit 100 of the image forming system 1 for connection processing. In step S1, the control unit 100 causes the image forming unit 200 to form a test chart on the sheet P. Specifically, a first recording head discharges ink droplets (droplets) onto the sheet P. Then, the sheet P is sent in the sheet conveyance direction X, and a second recording head discharges ink droplets (droplets) in an area partially overlapping the area in which the ink droplets (droplets) have been discharged on the sheet P. The test chart is formed by this method.

In step S2, when the sensor 108-1 detects the sheet P, the control unit 100 causes the scanner 140 to read the test chart formed of the dot discharge pattern on the sheet P, stores the read image in the NVRAM 105, and analyzes the read image in the NVRAM 105 by the image reading/analysis processing unit 118.

In step S3, the control unit 100 determines whether a streak or unevenness is detected in the analysis of the read image. When a streak or unevenness is detected (Yes in step S3), in step S4, the control unit 100 executes the connection processing of applying the connection pattern to an overlapping portion (i.e., a connection portion). In other words, the control unit 100 changes the dot discharge pattern in the connection portion based on the image read by the scanner 140.

In step S5, the control unit 100 causes the image forming unit 200 to form a test chart again on the sheet P. In step S6, the control unit 100 causes the scanner 140 to read the test chart formed again, and analyzes the test chart read by the scanner 140.

In step S7, the control unit 100 determines whether a streak or unevenness is detected in the analysis of the read image. When a streak or unevenness is detected (Yes in step S7), the process returns to step S4 and repeats the process again from the connection processing. The control unit 100 uses multiple connection patterns and sequentially switches the connection pattern from a connection pattern with small droplets to a connection pattern with large droplets until a streak or unevenness is prevented. When neither streak nor unevenness is detected in step S3 or S7 (No in step S3 or S7), the control unit 100 ends the control executed for the connection processing.

The connection processing will be described below in detail. As described above, a streak or unevenness may occur in the overlapping ranges indicated by the dashed lines Oa, Ob, and Oc in FIG. 2. Even when the ink droplets are discharged in a gradation pattern to prevent a streak, unevenness may occur instead of the streak.

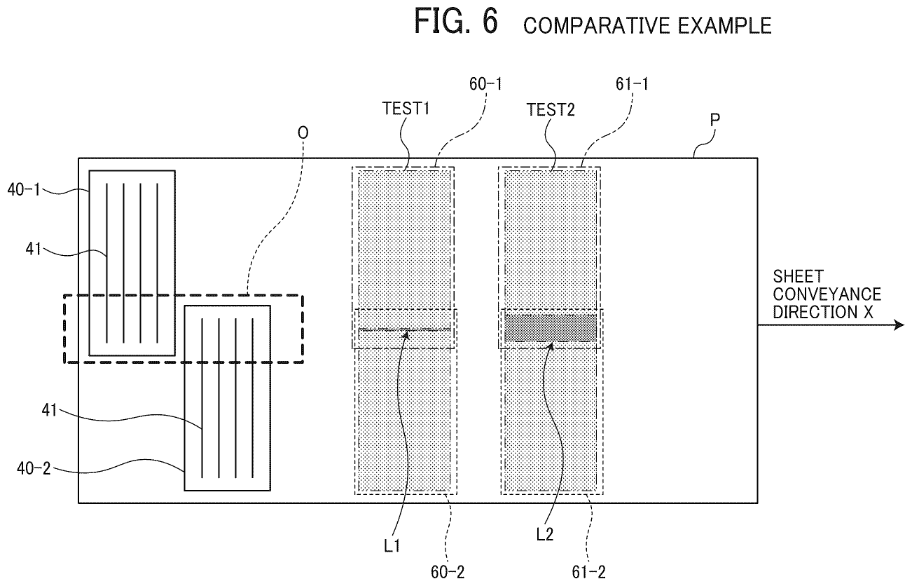

FIGS. 6 to 8 are diagrams illustrating a principle of occurrence of a streak and unevenness in a connection portion. As illustrated in FIG. 6, a first recording head 40-1 and a second recording head 40-2 are alternately arranged in a staggered manner. An end of the first recording head 40-1 and an end of the second recording head 40-2 overlap each other in the sheet conveyance direction X. In other words, the first recording head 40-1 and the second recording head 40-2 overlap each other in a portion indicated by the dashed line O in FIG. 6.

For example, the arrangement of the first recording head 40-1 and the second recording head 40-2 corresponds to the arrangement between the recording heads for the same color: a right end of the recording head 40K-1 and a left end of the recording head 40K-2, a right end of the recording head 40K-2 and a left end of the recording head 40K-3, or a right end of the recording head 40K-3 and a left end of the recording head 40K-4, in FIG. 2.

For example, the first recording head 40-1 and the second recording head 40-2 form two test charts TEST1 and TEST2 illustrated in FIG. 6 The test chart TEST1 is formed by discharging ink droplets (droplets) in a first dot discharge pattern onto the sheet P by the first recording head 40-1, then sending the sheet P in the sheet conveyance direction X, and discharging ink droplets (droplets) in a second dot discharge pattern by the second recording head 40-2 in an area partially overlapping the area in which the ink droplets (droplets) have been discharged in the first dot discharge pattern on the sheet P. The dot discharge pattern may be referred to simply as a dot pattern.

In the sheet P illustrated in FIG. 6, dots in a frame 60-1 are formed by the first recording head 40-1 in the first dot discharge pattern, and dots in a frame 60-2 are formed by the second recording head 40-2 in the second dot discharge pattern. The area in which the dots are formed in the second dot discharge pattern includes a part of the area in which the dots are formed in the first dot discharge pattern on the sheet P. Accordingly, the first dot discharge pattern and the second dot discharge pattern are mixed in a range (i.e., the connection portion) where the frame 60-1 and the frame 60-2 illustrated in FIG. 6 overlap each other. This overlapping range is referred to as the “connection portion.”

The test chart TEST2 illustrates a different result from the test chart TEST1. Dots of the test chart TEST2 are formed by the same operation for the test chart TEST1. In the sheet P illustrated in FIG. 6, dots in a frame 61-1 are formed by the first recording head 40-1 in the first dot discharge pattern, and dots in a frame 61-2 are formed by the second recording head 40-2 in the second dot discharge pattern. The area of the frame 61-1 and the area of the frame 61-2 overlapping each other as illustrated in FIG. 6 is referred to as the “connection portion.”

The test chart TEST1 and the test chart TEST2 are both completed images formed on the sheet P by the first dot discharge pattern and the second dot discharge pattern. In the test chart TEST1, since the image is formed without performing the connection processing, a streak L1 occurs in the connection portion. In the test chart TEST2, as a result of performing the connection processing with the gradation pattern in order to eliminate the streak L1, unevenness L2 occurs in the connection portion.

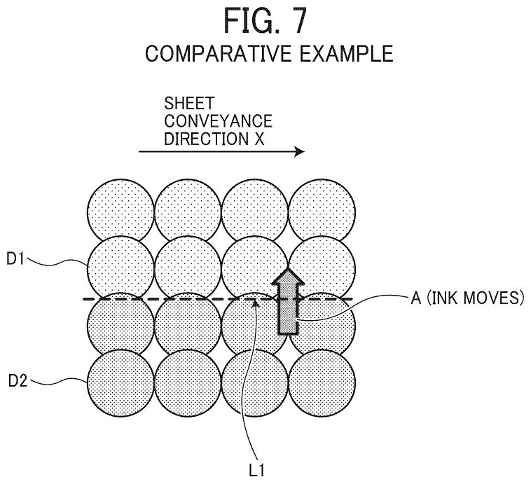

FIG. 7 is a diagram illustrating an arrangement of dots formed of ink landed in the connection portion. As illustrated in FIG. 7, when the connection processing is not performed as in the test chart TEST1, ink droplets D2 discharged from the second recording head 40-2 may move in the direction indicated by arrow A illustrated in FIG. 7 and overlap the positions of ink droplets D1 landed from the first recording head 40-1 due to insufficient adjustment of the recording heads and variations in the behavior of the ink droplets. Thus, the streak L1 may occur due to the overlap of these dots.

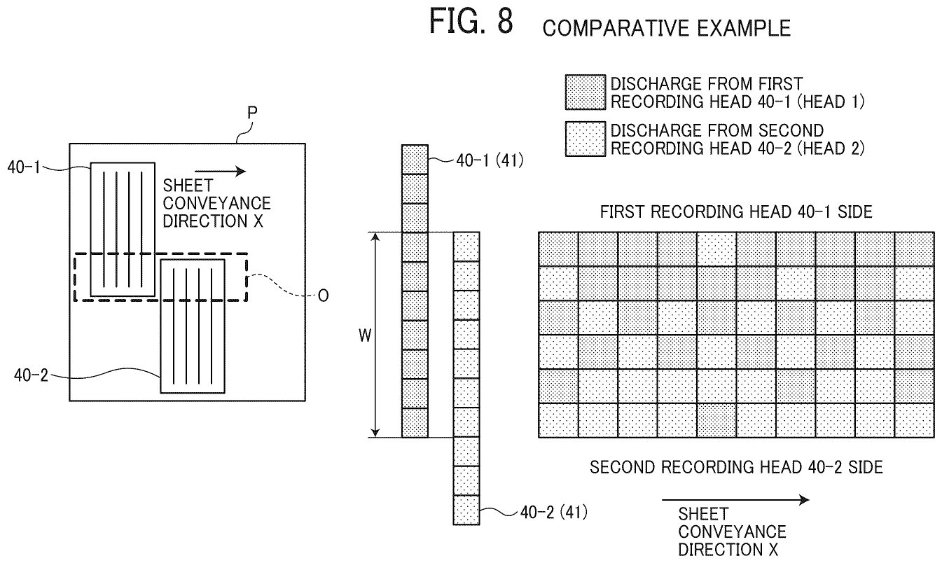

FIG. 8 is a diagram illustrating the connection portion to which the gradation pattern is applied. As illustrated in FIG. 8, this pattern is a discharge pattern in which the number of dots (ink droplets) discharged by the second recording head 40-2 is decreased and the number of dots discharged by the first recording head 40-1 is increased toward the first recording head 40-1, and the number of dots discharged by the first recording head 40-1 is decreased and the number of dots discharged by the second recording head 40-2 is increased toward the second recording head 40-2 in a connection portion W. In other words, the proportion of the dots discharged by the first recording head 40-1 and the proportion of the dots discharged by the second recording head 40-2 are gradually interchanged from the first recording head 40-1 toward the second recording head 40-2 like gradation, which is referred to as the gradation pattern. In other words, the control unit 100 causes the first recording head 40-1 and the second recording head 40-2 to form the dot patterns (e.g., a first dot pattern and a second dot pattern) with gradation in the connection portion.

In FIG. 8, dark shaded squares indicate the dots discharged by the first recording head 40-1, and light shaded squares indicate the dots discharged by the second recording head 40-2. By applying such a gradation pattern, the behavior of the ink droplets discharged from the first recording head 40-1 and the behavior of the ink droplets discharged from the second recording head 40-2 can be distributed to prevent the streak L1.

In this gradation pattern, the unevenness L2 may occur in the connection portion W due to the influence of drive frequency characteristics. In the connection portion W, since the number of times of continuous discharge from each nozzle in the nozzle row 41 of the same recording head is different for each nozzle in the sheet conveyance direction X, the streak L1 can be prevented, but the unevenness L2 may occur as a side effect.

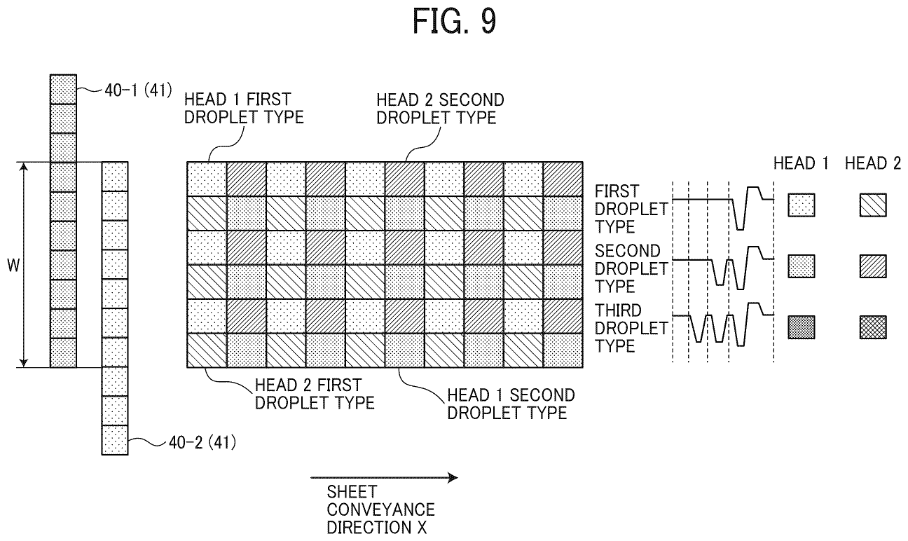

FIGS. 9 to 12 are diagrams each illustrating an example of the connection pattern for reducing the streak L1 and the unevenness L2. The connection pattern is a pattern for changing the dot configuration. FIG. 9 is a diagram illustrating a first example of the connection pattern.

As illustrated in FIG. 9, among a first droplet type, a second droplet type, and a third droplet type, the first recording head 40-1 and the second recording head 40-2 use the connection pattern in which the first droplet type and the second droplet type are mixed to change the dot configuration.

As illustrated in FIG. 9, the first droplet type and the second droplet type are mixed in the discharge pattern of the first recording head 40-1. For example, in FIG. 9, the discharge pattern of the first recording head 40-1 includes the first droplet type and the second droplet type arranged in a staggered manner. In the discharge pattern of the second recording head 40-2 as well, the first droplet type and the second droplet type are mixed. The discharge pattern of the second recording head 40-2 includes the first droplet type and the second droplet type arranged in a staggered manner in void areas of the discharge pattern of the first recording head 40-1. Thus, the streak and unevenness can be reduced by changing the dot configuration.

In other words, the control unit 100 controls the first recording head 40-1 to discharge the liquid droplets onto a part of the connection portion to form the first dot pattern in the part of the connection portion and controls the second recording head 40-2 to discharge the liquid droplets onto another part of the connection portion to form the second dot pattern in said another part of the connection portion. The liquid droplets have a first droplet type having a first droplet size and a second droplet type having a second droplet size larger than the first droplet size to form the first dot pattern and the second dot pattern having a mixture of the first droplet type and the second droplet in the connection portion.

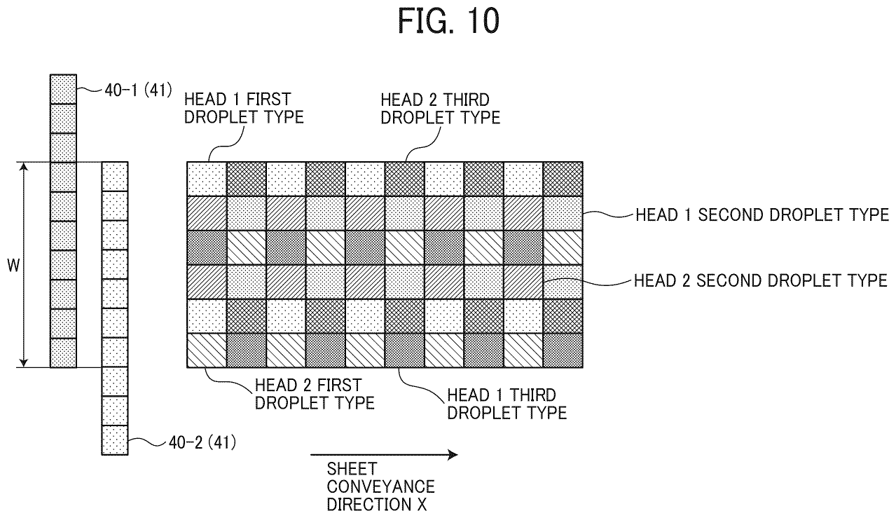

FIG. 10 is a diagram illustrating a second example of the connection pattern. As illustrated in FIG. 10, the first recording head 40-1 and the second recording head 40-2 further use the third droplet type, and use the connection pattern in which the first droplet type, the second droplet type, and the third droplet type are mixed to change the dot configuration. The pattern illustrated in FIG. 10 is one example.

The first droplet type and the second droplet type may be a large droplet and a medium droplet, a medium droplet and a small droplet, or a large droplet and a small droplet, respectively. The second droplet type may be referred to as an ink droplet (droplet) with the other (different) droplet size. Thus, the streak and unevenness can be reduced by changing the dot configuration.

For example, the control unit 100 controls the first recording head 40-1 to discharge, onto the part of the connection portion, the liquid droplets further having a third droplet type having a third droplet size larger than the second droplet type to form the first dot pattern in the part of the connection portion; and controls the second recording head 40-2 to discharge, onto said another part of the connection portion, the liquid droplets having the first droplet type, the second droplet type, and the third droplet type to form the second dot pattern in said another part of the connection portion, to form the first dot pattern and the second dot pattern having a mixture of the first droplet type, the second droplet type, and the third droplet type in the connection portion.

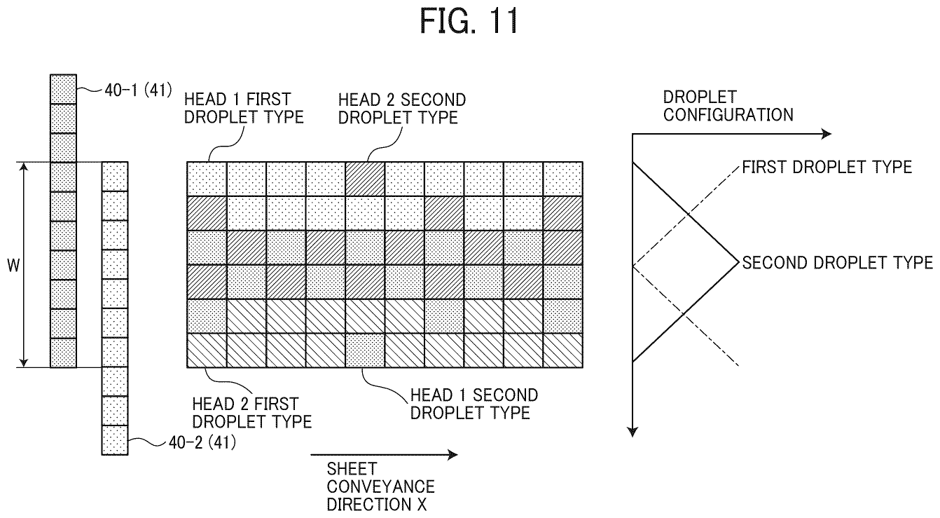

FIG. 11 is a diagram illustrating a third example of the connection pattern. The connection pattern illustrated in FIG. 11 is a pattern in which the first droplet type and the second droplet type are set in the gradation pattern illustrated in FIG. 8. As illustrated in the graph of FIG. 11, the number of droplets of the first droplet type decreases toward the center line of the connection portion W, and the number of droplets of the second droplet type increases toward the center line of the connection portion W. In this method, since pattern recognizability of the connection portion W is reduced by gradation, the streak and unevenness can be further reduced.

Specifically, the first recording head 40-1 has nozzles arrayed in a nozzle array direction orthogonal to the conveyance direction and discharges the liquid droplets from the nozzles. The second recording head 40-2 has nozzles arrayed in the nozzle array direction and discharges the liquid droplets from the second nozzles. The first recording head 40-1 and the second recording head 40-2 are arranged in a staggered manner in the conveyance direction. The sheet P, as a recording medium or simply as a medium, is conveyed in the conveyance direction. A part of the first recording head 40-1 and a part of the second recording head 40-2 are overlapped in the nozzle array direction to from the connection portion W. The control unit 100 controls the first recording head 40-1 and the second recording head 40-2 to form the first dot pattern and the second dot pattern having a gradation pattern having: the liquid droplets of the first droplet type, a number of which decreases toward a center of the connection portion in the nozzle array direction; and the liquid droplets of the second droplet type, a number of which increases toward the center of the connection portion in the nozzle array direction.

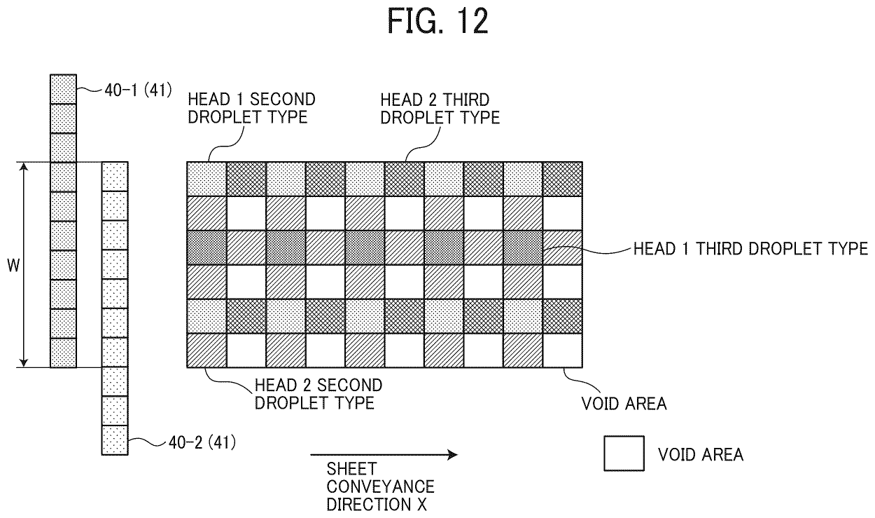

FIG. 12 is a diagram illustrating a fourth example of the connection pattern. The connection pattern includes a void area in addition to different droplet types (e.g., large, medium, and small droplets). For example, the connection pattern includes the void area, the second droplet type, and the third droplet type. The void area is a region into which ink droplets are not discharged. In the dot configurations of the first to third examples of the connection pattern, since multiple droplet types are mixed, slight partial unevenness may occur. In the fourth example of the connection pattern, the void areas may prevent partial unevenness.

Specifically, the control unit 100 controls the first recording head 40-1 and the second recording head 40-2 not to discharge the liquid droplets in each part of the first dot pattern and the second dot pattern to form void areas scattered in the connection portion W.

Although some embodiments of the present disclosure have been described above, the above-described embodiments and modifications thereof are just examples and not intended to limit the scope of the present disclosure. The above-described novel embodiments and modifications can be implemented in other various forms, and various omissions, replacements, and changes can be made without departing from the scope of the present disclosure. In addition, the embodiments and modifications or variations thereof are included in the scope and the gist of the invention, and are included in the invention described in the claims and the equivalent scopes thereof.

Aspects of the present disclosure are, for example, as follows.

### Aspect 1

A liquid discharge apparatus includes a first recording head, a second recording head, a reader, and a discharge controller. The first recording head discharges droplets in a first dot discharge pattern onto a recording medium. The second recording head discharges droplets in a second dot discharge pattern so as to partially include a range in which the droplets have been discharged in the first dot discharge pattern on the recording medium. The reader reads an image formed in the first dot discharge pattern and the second dot discharge pattern from the recording medium. The discharge controller changes a dot configuration of the droplets of the first recording head and the droplets of the second recording head in a range in which the first dot discharge pattern and the second dot discharge pattern are mixed on the recording medium based on the image read by the reader.

In other words, a liquid discharge apparatus includes a first head, a second head, and circuitry. The first head discharges liquid droplets onto a medium to form a first dot pattern in a first area on the medium. The second head discharges the liquid droplets onto the medium to form a second dot pattern in a second area on the medium. The second area partially overlaps the first area in a connection portion. The circuitry: controls the first head to discharge, onto a part of the connection portion, the liquid droplets having a first droplet type having a first droplet size and a second droplet type having a second droplet size larger than the first droplet size to form the first dot pattern in the part of the connection portion; and controls the second head to discharge, onto another part of the connection portion, the liquid droplets having the first droplet type and the second droplet type to form the second dot pattern in said another part of the connection portion, to form the first dot pattern and the second dot pattern having a mixture of the first droplet type and the second droplet in the connection portion.

### Aspect 2

In the liquid discharge apparatus according to Aspect 1, the discharge controller changes a part of multiple dots in the range to dots of droplets of a different size in the first dot discharge pattern and the second dot discharge pattern.

In other words, the circuitry controls the first head and the second head to from the first dot pattern and the second dot pattern in the connection portion having the mixture of the first droplet type and the second droplet arranged in a staggered manner in the connection portion.

### Aspect 3

In the liquid discharge apparatus according to Aspect 1 or 2, dot discharge patterns of the first dot discharge pattern and the second dot discharge pattern in the range include a gradation pattern.

In other words, the first head has first nozzles arrayed in a nozzle array direction, and the first head discharges the liquid droplets from the first nozzles. The second head has second nozzles arrayed in the nozzle array direction, and the second head discharges the liquid droplets from the second nozzles. The first head and the second head are arranged in a staggered manner in a conveyance direction orthogonal to the nozzle array direction. The medium is conveyed in the conveyance direction. A part of the first head and a part of the second head are overlapped in the nozzle array direction to from the connection portion. The circuitry controls the first head and the second head to form the first dot pattern and the second dot pattern having a gradation pattern having: the liquid droplets of the first droplet type, a number of which decreases toward a center of the connection portion in the nozzle array direction; and the liquid droplets of the second droplet type, a number of which increases toward the center of the connection portion in the nozzle array direction.

### Aspect 4

In the liquid discharge apparatus according to any one of Aspects 1 to 3, the discharge controller changes a part of multiple dots in the range to void areas in the first dot discharge pattern and the second dot discharge pattern.

In other words, the circuitry controls the first head and the second head not to discharge the liquid droplets in each part of the first dot pattern and the second dot pattern to form void areas scattered in the connection portion.

### Aspect 5

The liquid discharge apparatus according to any one of Aspects 1 to 4, further includes a reader to read an image formed of the first dot pattern and the second dot pattern on the medium. The circuitry changes the first dot pattern and the second dot pattern in the connection portion based on the image read by the reader.

### Aspect 6

In the liquid discharge apparatus according to any one of Aspects 1 to 5, the circuitry controls the first head to discharge, onto the part of the connection portion, the liquid droplets further having a third droplet type having a third droplet size larger than the second droplet type to form the first dot pattern in the part of the connection portion; and controls the second head to discharge, onto said another part of the connection portion, the liquid droplets having the first droplet type, the second droplet type, and the third droplet type to form the second dot pattern in said another part of the connection portion, to form the first dot pattern and the second dot pattern having a mixture of the first droplet type, the second droplet type, and the third droplet type in the connection portion.

### Aspect 7

A liquid discharge system includes the liquid discharge apparatus according to any one of Aspects 1 to 6 and a processing apparatus for the recording medium.

In other words, a liquid discharge system includes the liquid discharge apparatus according to any one of Aspects 1 to 6, to form an image on the medium and a processing apparatus including at least one of: a feeder to feed the medium to the liquid discharge apparatus; a dryer to dry the image formed on the medium by the liquid discharge apparatus; or an ejector to stack the medium on which the image has dried by the dryer.

### Aspect 8

In a method executed by a liquid discharge apparatus, the method includes: a process of discharging, by a first recording head, droplets in a first dot discharge pattern onto a recording medium; a process of discharging, by a second recording head, droplets in a second dot discharge pattern so as to partially include a range in which the droplets have been discharged in the first dot discharge pattern on the recording medium; a process of reading, by a reader, an image formed in the first dot discharge pattern and the second dot discharge pattern from the recording medium; and a process of changing a dot configuration of the droplets of the first recording head and the droplets of the second recording head in a range in which the first dot discharge pattern and the second dot discharge pattern are mixed on the recording medium based on the image read by the reader.

In other words, a liquid discharge method includes: causing a first head to discharge liquid droplets onto a medium to form a first dot pattern in a first area on the medium; causing a second head to discharge the liquid droplets onto the medium to form a second dot pattern in a second area on the medium, the second area partially overlapping the first area in a connection portion; controlling the first head to discharge, onto a part of the connection portion, the liquid droplets having: a first droplet type having a first droplet size; and a second droplet type having a second droplet size larger than the first droplet size, to form the first dot pattern in the part of the connection portion; and controlling the second head to discharge, onto another part of the connection portion, the liquid droplets having: the first droplet type; and the second droplet type, to form the second dot pattern in said another part of the connection portion, to form the first dot pattern and the second dot pattern having a mixture of the first droplet type and the second droplet in the connection portion.

### Aspect 9

A program causing a computer to execute: a step of discharging, by a first recording head, droplets in a first dot discharge pattern onto a recording medium; a step of discharging, by a second recording head, droplets in a second dot discharge pattern so as to partially include a range in which the droplets have been discharged in the first dot discharge pattern on the recording medium; a step of reading, by a reader, an image formed in the first dot discharge pattern and the second dot discharge pattern from the recording medium; and a step of changing a dot configuration of the droplets of the first recording head and the droplets of the second recording head in a range in which the first dot discharge pattern and the second dot discharge pattern are mixed on the recording medium based on the image read by the reader.

In other words, a non-transitory recording medium storing a plurality of instructions which, when executed by one or more processors, causes the one or more processors to perform a method. The method includes: causing a first head to discharge liquid droplets onto a medium to form a first dot pattern in a first area on the medium; causing a second head to discharge the liquid droplets onto the medium to form a second dot pattern in a second area on the medium, the second area partially overlapping the first area in a connection portion; controlling the first head to discharge, onto a part of the connection portion, the liquid droplets having: a first droplet type having a first droplet size; and a second droplet type having a second droplet size larger than the first droplet size, to form the first dot pattern in the part of the connection portion; and controlling the second head to discharge, onto another part of the connection portion, the liquid droplets having: the first droplet type; and the second droplet type, to form the second dot pattern in said another part of the connection portion, to form the first dot pattern and the second dot pattern having a mixture of the first droplet type and the second droplet in the connection portion.

As described above, according to one aspect of the present disclosure, a liquid discharge apparatus, a liquid discharge system, a liquid discharge method, and a storage medium storing a plurality of instructions can be provided that prevent a streak and unevenness in a connection portion.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

Any one of the above-described operations may be performed in various other ways, for example, in an order different from the one described above.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

1. A liquid discharge apparatus comprising:
a first head to discharge liquid droplets onto a medium to form a first dot pattern in a first area on the medium;
a second head to discharge the liquid droplets onto the medium to form a second dot pattern in a second area on the medium, the second area partially overlapping the first area in a connection portion; and
circuitry configured to:
control the first head to discharge, onto a part of the connection portion, the liquid droplets having:
a first droplet type having a first droplet size; and
a second droplet type having a second droplet size larger than the first droplet size,
to form the first dot pattern in the part of the connection portion; and
control the second head to discharge, onto another part of the connection portion, the liquid droplets having:
the first droplet type; and
the second droplet type,
to form the second dot pattern in said another part of the connection portion,
to form the first dot pattern and the second dot pattern having a mixture of the first droplet type and the second droplet type in the connection portion.

2. The liquid discharge apparatus according to claim 1,
wherein the circuitry is further configured to:
control the first head and the second head to from the first dot pattern and the second dot pattern in the connection portion having the mixture of the first droplet type and the second droplet type arranged in a staggered manner in the connection portion.

3. The liquid discharge apparatus according to claim 1,
wherein the first head has first nozzles arrayed in a nozzle array direction,
the first head discharges the liquid droplets from the first nozzles,
the second head has second nozzles arrayed in the nozzle array direction,
the second head discharges the liquid droplets from the second nozzles,
the first head and the second head are arranged in a staggered manner in a conveyance direction orthogonal to the nozzle array direction, the medium conveyed in the conveyance direction,
a part of the first head and a part of the second head are overlapped in the nozzle array direction to from the connection portion,
the circuitry is further configured to control the first head and the second head to form the first dot pattern and the second dot pattern,
having a gradation pattern having:
the liquid droplets of the first droplet type, a number of which decreases toward a center of the connection portion in the nozzle array direction; and
the liquid droplets of the second droplet type, a number of which increases toward the center of the connection portion in the nozzle array direction.

4. The liquid discharge apparatus according to claim 1,
wherein the circuitry is further configured to:
control the first head and the second head not to discharge the liquid droplets in each part of the first dot pattern and the second dot pattern,
to form void areas scattered in the connection portion.

5. The liquid discharge apparatus according to claim 1, further comprising a reader to read an image formed of the first dot pattern and the second dot pattern on the medium,
wherein the circuitry is further configured to change the first dot pattern and the second dot pattern in the connection portion based on the image read by the reader.

6. The liquid discharge apparatus according to claim 1,
wherein the circuitry is further configured to:
control the first head to discharge, onto the part of the connection portion, the liquid droplets further having
a third droplet type having a third droplet size larger than the second droplet type,
to form the first dot pattern in the part of the connection portion; and
control the second head to discharge, onto said another part of the connection portion, the liquid droplets having
the first droplet type, the second droplet type, and the third droplet type,
to form the second dot pattern in said another part of the connection portion,
to form the first dot pattern and the second dot pattern having a mixture of the first droplet type, the second droplet type, and the third droplet type in the connection portion.

7. A liquid discharge system comprising:
the liquid discharge apparatus according to claim 1, to form an image on the medium; and
a processing apparatus including at least one of:
a feeder to feed the medium to the liquid discharge apparatus;
a dryer to dry the image formed on the medium by the liquid discharge apparatus; or
an ejector to stack the medium on which the image has dried by the dryer.

8. A liquid discharge method comprising:
causing a first head to discharge liquid droplets onto a medium to form a first dot pattern in a first area on the medium;
causing a second head to discharge the liquid droplets onto the medium to form a second dot pattern in a second area on the medium, the second area partially overlapping the first area in a connection portion;
controlling the first head to discharge, onto a part of the connection portion, the liquid droplets having:
a first droplet type having a first droplet size; and
a second droplet type having a second droplet size larger than the first droplet size,
to form the first dot pattern in the part of the connection portion; and
controlling the second head to discharge, onto another part of the connection portion, the liquid droplets having:
the first droplet type; and
the second droplet type,
to form the second dot pattern in said another part of the connection portion,
to form the first dot pattern and the second dot pattern having a mixture of the first droplet type and the second droplet type in the connection portion.

9. A non-transitory recording medium storing a plurality of instructions which, when executed by one or more processors, causes the one or more processors to perform a method, comprising:
causing a first head to discharge liquid droplets onto a medium to form a first dot pattern in a first area on the medium;
causing a second head to discharge the liquid droplets onto the medium to form a second dot pattern in a second area on the medium, the second area partially overlapping the first area in a connection portion;
controlling the first head to discharge, onto a part of the connection portion, the liquid droplets having:
a first droplet type having a first droplet size; and
a second droplet type having a second droplet size larger than the first droplet size,
to form the first dot pattern in the part of the connection portion; and
controlling the second head to discharge, onto another part of the connection portion, the liquid droplets having:
the first droplet type; and
the second droplet type,
to form the second dot pattern in said another part of the connection portion,
to form the first dot pattern and the second dot pattern having a mixture of the first droplet type and the second droplet type in the connection portion.
